(19) United States
(12) Patent Application Publication
(10) Pub. No.: US 2006/0152561 A1
(43) Pub. Date: Jul. 13, 2006

(54) Ink bag assembly

(76) Inventors: David Anthony Belfiore, Landenberg, PA (US); Thomas Patrick Daly, Aston, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/313,036

(22) Filed: Dec. 20, 2005

Related U.S. Application Data
(60) Provisional application No. 60/640,632, filed on Dec. 31, 2004.

(51) Int. Cl. B41J 2/175

(52) U.S. Cl. 347/85

(57) ABSTRACT

The embodiments of the present invention utilize an ink supply bag assembly contained in a housing, the ink supply bag comprising a printed circuit board, thereby allowing a printer to recognize and identify the ink bag assembly as well as the ink contained therein.

### CROSS-REFERENCE TO RELATED APPLICATIONS

This application claims priority under 35 U.S.C. §119 from U.S. Provisional Application Ser. No. 60/640,432 (filed Dec. 31, 2004), the disclosure of which is incorporated by reference herein for all purposes as if fully set forth.

### BACKGROUND

Typically, industrial and personal printing units have replaceable hard-sided ink cartridges, where subsequent to removal of the ink, the entire cartridge is discarded. Since printing units may use multiple cartridges simultaneously, and may require frequent replacement, the discarding of ink cartridges is problematic as it results in large amounts of waste, which is an environmental concern.

Furthermore, due to the frequent replacement of the ink cartridges, particularly in industrial printing processes, and the multitude of colors utilized in a single printing unit, an operator may mistakenly insert the incorrect color or ink type into the printing unit. This may lead to the use of improper inks for a particular application where the necessary ink fastness is not present for a particular media (i.e. a paper of fabric) or the use of an incorrect color. These problems result in a process that is neither time efficient nor cost efficient.

### SUMMARY OF THE INVENTION

The embodiments of the present invention contemplate an ink bag assembly comprising an ink supply bag; and a fitment that is fluidly connected to the ink supply bag, wherein the fitment comprises an engageable member having a printed circuit board integrated therein or affixed thereto; and the fitment further comprises a fluid outlet comprising a fluid barrier.

The embodiments of the present invention also contemplate a housing for the ink bag assembly, the housing comprising a lid and a body, where the body comprises a floor, a plurality of sidewalls, a proximal end having a proximal wall, and a distal end optionally having a distal wall, wherein the lid and body are capable of being mated so that the lid encloses the body to define a containment area. The housing also includes a fitment receiving mechanism in the proximal end of the containment area to provide assistance in the alignment of the fitment of the ink bag assembly.

The embodiments of the present invention also contemplate an ink cartridge, where the ink cartridge is the combination of the housing and the ink bag assembly contained therein.

The embodiments of the present invention also contemplate a method of loading the embodiments of the housing containing the ink bag assembly into a printer by inserting an embodiment of the ink bag assembly of the present invention into a housing to form an ink cartridge; and inserting the ink cartridge into a printer.

Other features and advantages of the embodiments of the present invention will be or become apparent to one skilled in the art upon examination of the following drawings and detailed description. It is intended that all such additional features and advantages be included within this description, be within the scope of the present invention, and be protected by the accompanying claims.

### BRIEF DESCRIPTION OF THE DRAWINGS

Many aspects of the embodiments of the present invention can be more fully understood with reference to the following drawings. The components set forth in the drawings are not necessarily to scale. Moreover, in the drawings, the reference numerals designate corresponding parts throughout the several views.

FIG. 1 depicts an elevated frontal view of an embodiment of an ink bag assembly.

FIG. 2 depicts an elevated frontal view of an embodiment of an ink bag assembly.

FIG. 3 depicts a frontal view of an embodiment of a fitment.

FIG. 4 depicts a frontal view of an embodiment of a fitment.

FIG. 5 depicts an exploded side view of an embodiment of a housing having an embodiment of an ink bag assembly inserted therein.

FIG. 6 depicts an elevated side view of an embodiment of an ink bag assembly inserted into an embodiment of a housing.

FIG. 7 depicts an elevated side view of an embodiment of a housing, wherein the lid is closed.

FIG. 8 depicts a frontal view of an embodiment of an ink cartridge.

FIG. 9 depicts an elevated side view of an embodiment of an ink cartridge.

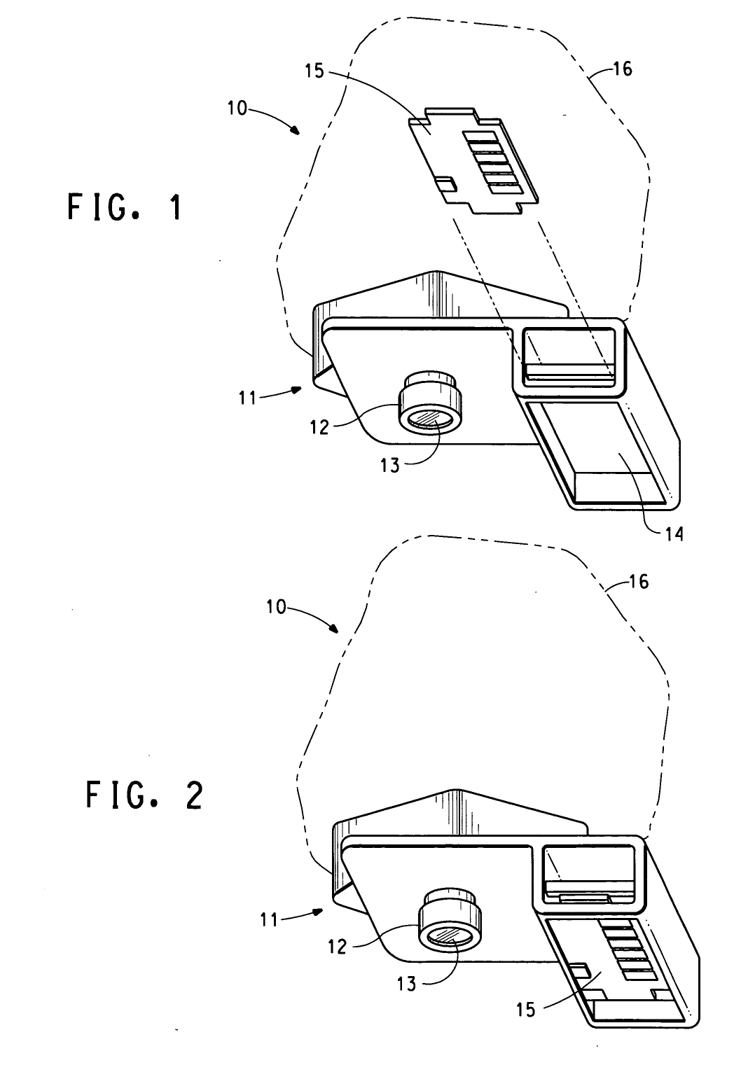

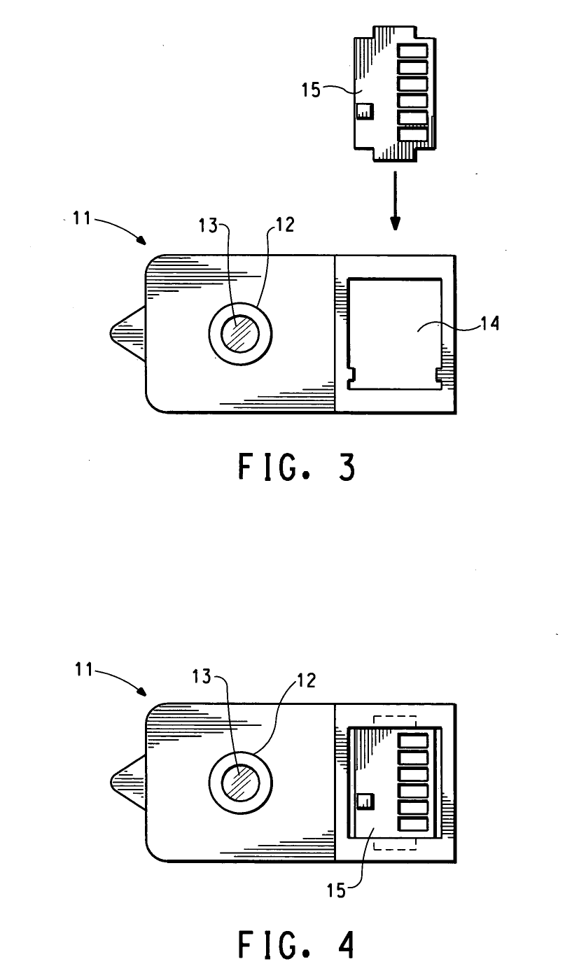

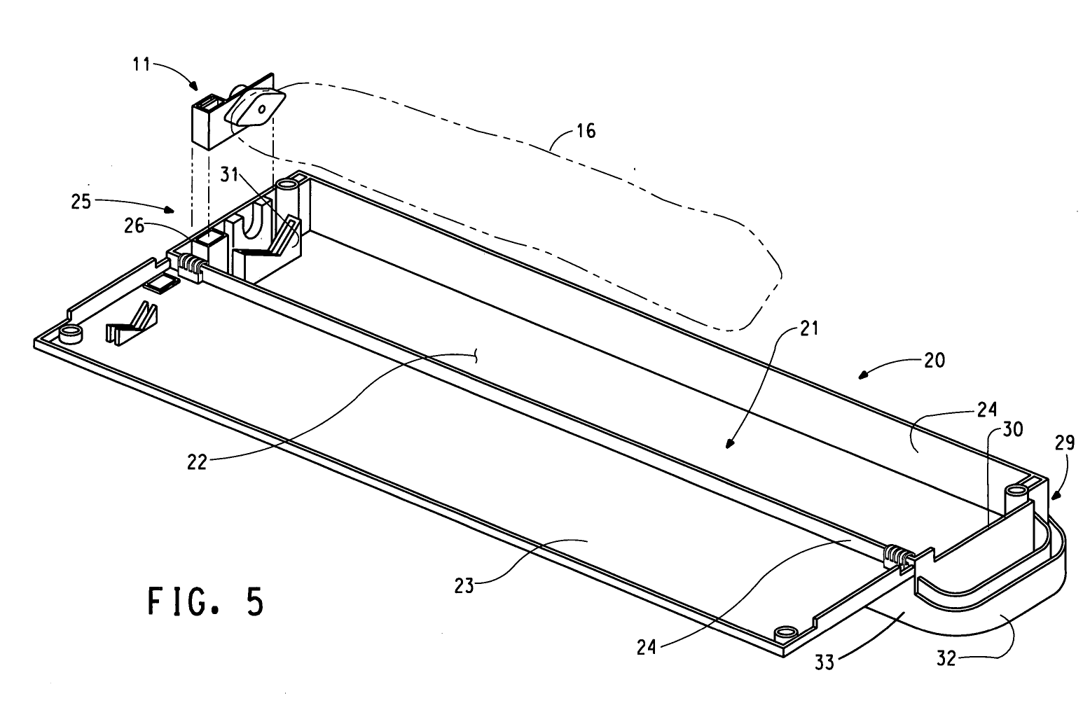

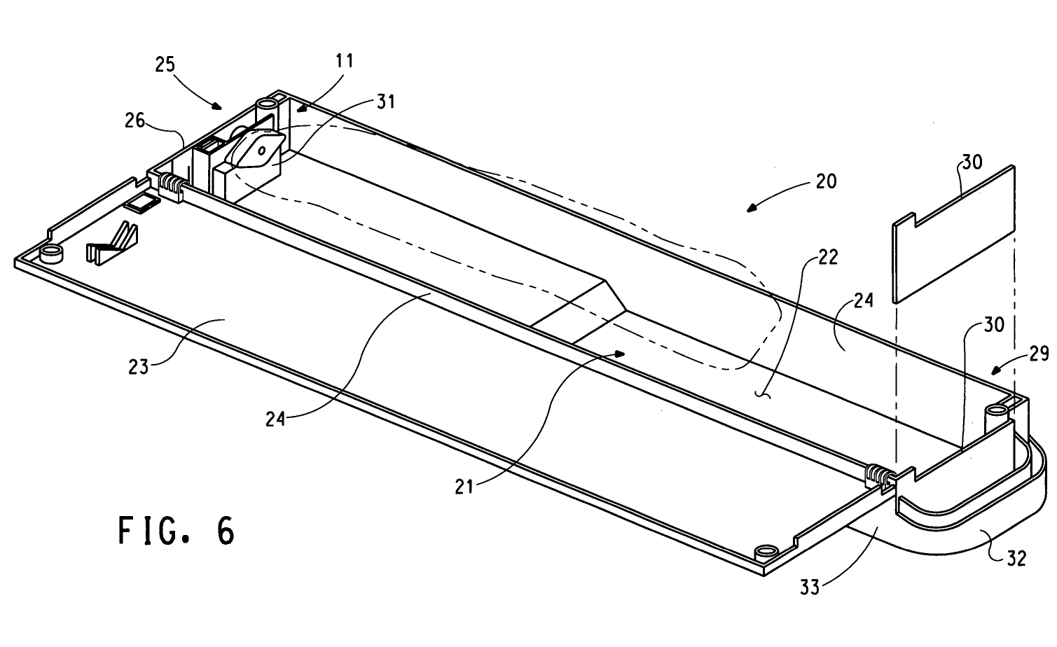

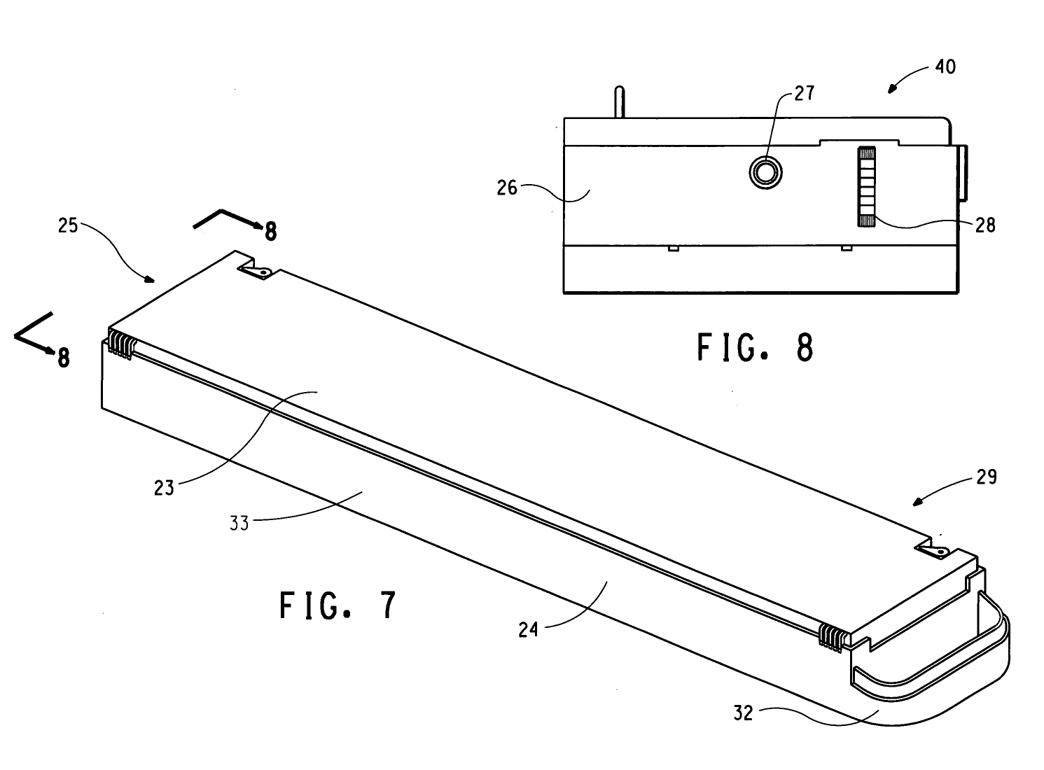

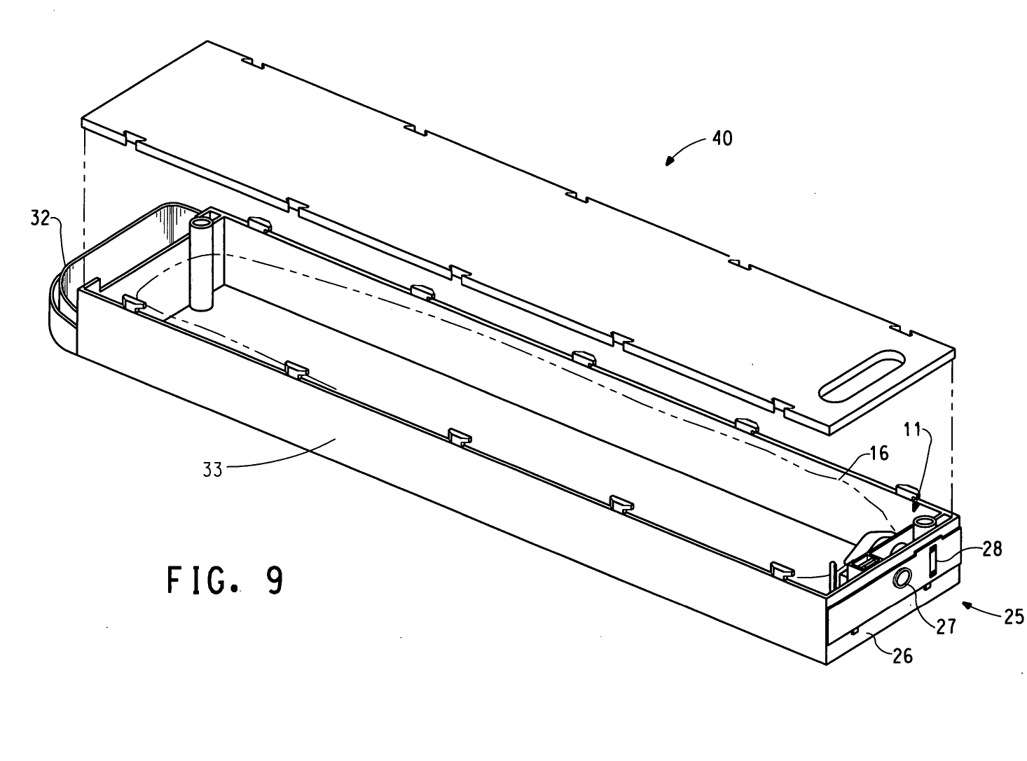

### DETAILED DESCRIPTION OF THE PREFERRED EMBODIMENTS

Where a range of numerical values is recited herein, unless otherwise stated, the range is intended to include the endpoints thereof, and all integers and fractions within the range. It is not intended that the scope of the various embodiments of the invention be limited to the specific values recited when defining a range. Moreover, all ranges set forth herein are intended to include not only the particular ranges specifically described, but also any combination of values therein, including the minimum and maximum values recited.

The embodiments of the present invention enable the use of an ink bag assembly comprising a fitment and a printed circuit board integrated therein or affixed thereto in conjunction with a ink supply bag (preferably disposable, soft-sided and flexible); wherein the printed circuit board allows for the transmission of information including, but not limited to, color, lot numbers, manufacturing location, etc. Furthermore, the use of the printed circuit board enables a printing unit (e.g. industrial printers, personal printers and the like) to recognize the disposable ink supply bag; such that an operator may be prevented from inserting the incorrect color or type of ink.

The embodiments of the present invention further contemplate a reuseable housing capable of containing the ink bag assembly as described herein, thereby forming a printing cartridge capable of being inserted into a printing unit, wherein the housing provides structural integrity and consistency to the ink bag and aids in ensuring the proper positioning of the means for fluid communication and printed circuit board.

The embodiments of the present invention further contemplate an ink cartridge comprising a housing having an ink bag assembly contained therein, such that the ink cartridge may be inserted into a printing unit.

An embodiment of an ink bag assembly (10) comprises (a) an ink supply bag (16); and (b) a fitment (11) fluidly connected to the ink supply bag (16) via a means for fluid communication (12), wherein the fitment (11) comprises an engageable member (14) having a printed circuit board (15) integrated therein or affixed thereto.

The ink supply bag (16) may be any bag that is known in the art. Preferably the ink supply bag (16) is disposable and comprises a flexible multi-ply laminate material having at least one plastic layer such as, for example, polyethylene or nylon. Additional layers may include metal foil if high gas barrier properties are desired. Examples of suitable commercially available ink supply bag materials include, but are not limited to, the Cepac HD100 (available from Cadillac Products Packaging Company of Troy Mich.) and the Fres-pet (available from Fres-co Systems USA of Telford, Pa.). The ink supply bag may be of any size typically found in the art.

The fitment (11) may be constructed of any material capable of maintaining its structural integrity during normal use, while also allowing for the integrating or affixing of the printed circuit board (15). Materials suitable for use as the fitment (11) include those materials known to those skilled in the art, but are not limited to, metal and plastic. For example a suitable plastic includes, but is not limited to, a low density or high density polyethylene, which can easily be connected to the ink supply bag via heat sealing. Examples of suitable commercially available low density or high density polyethylene fitments include, but are not limited to, those manufactured by Menshen Packaging USA of Waldwick, N.J. and Qosina Corporation of Edgewood, N.Y.

The fitment (11) and ink supply bag (16) are fluidly connected via a means for fluid communication, preferably a fluid outlet (12). Other means for fluid communication are well known to those skilled in the art. The fluid outlet (12) allows for the ink to exit from the ink supply bag (16) and into a printing unit. The fluid outlet (12) may comprise a fluid barrier (13), which acts to interrupt or prevent fluid flow until the printer engages with the ink supply bag (16). Suitable configurations of the fluid outlet (12) having a fluid barrier (13) include those known in the art including, but not limited to, an aperture/diaphragm or septum configuration (e.g. the septum is capable of being pierced using a means of fluid withdrawal as part of its method of removing the ink (e.g. a needle) from the ink supply bag (16)), or use of check valves or other automatically re-sealing fluid outlets such as, for example, the Clean-Clic® (available from the Innovative Packaging Netherlands (IPN) Company).

The fitment (11) and printed circuit board (15) may comprise a substantially unitary structure when the printed circuit board (15) is integrated with the engageable member (14), wherein the engagement member (14) is designed to accept the printed circuit board (15) in accordance with those techniques known in the art. For example, the engagement member (14) may engage with or “grab” the edges of the printed circuit board (15) to hold it in position. Alternatively, the printed circuit board (15) may be affixed to the engageable member (14) such that it may be easily fastened in place using an appropriate adhesive. The printed circuit board (15) must be positioned on the engageable member such that when the ink bag assembly (10) is inserted into the housing (20) and the ink cartridge (40) is inserted into and engaged with the printer, appropriate electrical contact is made with the printing unit to enable electronic communication between the printed circuit board (15) and the printer. The electronic communication provides for the relay of an electronic signal to provide information both to the printing unit and the operator, wherein such information includes general product information such as, for example, ink type, lot number, color and the like. Still further the printed circuit board (15) may act as an electronic key, wherein transmission of the correct signal allows for the printing unit to interface with the ink cartridge (40) and begin the withdrawal/flow of ink. Therefore, the use of incorrect inks or other fluids that could possibly damage the printing unit are prevented, along with damage occurring as a result of improper positioning of the ink supply assembly (10).

The printed circuit board (15) for use in the embodiments of the present invention may be any of those commonly known in the art and commercially available. Typically, printed circuit boards (15) are constructed according to the particular application for which they are used. Those skilled in the art would recognize and understand the appropriate printed circuit board (15) for use in the embodiments of the present invention capable of carrying out the desired functions.

The present invention also contemplates embodiments for a housing (preferably a re-useable housing) (20) for the ink bag assembly (10), wherein the housing (20) may be inserted and removed from the printing unit to allow for the replacement of an empty ink supply bag (16) with an entirely new ink bag assembly (10).

More specifically, the housing (20) comprises: (1) a lid (23); (2) a body (33) comprising a floor (22), a plurality of sidewalls (24), a proximal end (25) having a proximal wall (26), and a distal end (29) optionally having a distal wall (30), wherein the lid (23) and body (33) are removeably connected and define a containment area (21); and (3) a fitment receiving mechanism (31) in the proximal end (25) of the containment area (21) to allow insertion of the fitment (11) of the ink bag assembly (10).

The housing (20) may be constructed of any material capable of maintaining its structural integrity during normal use. Materials suitable for use in forming the housing (20) include those materials known to those skilled in the art, but are not limited to, metal and plastic. For example, a suitable plastic includes, but is not limited to, ABS plastics (plastics based on acrylonitrile-butadiene-styrene copolymers). The housing (20) can accommodate a variety of ink supply bags (16), although it is capable of receiving bags larger than those typically utilized in the art.

Preferably the housing (20) has a two-piece configuration, where the lid (23) is completely removable from the body (33). The lid (23) and body (33) are capable of being mated or connected so that the lid (23) encloses the body (33) to define the containment area (31), where the lid (23) may be snapped or otherwise replaced into position to provide the necessary structural integrity. Alternatively, the housing (20) may have a substantially unitary configuration such that the lid (23) may be connected to or mated with the body (33) via hinges.

The proximal wall (26) of the housing (20) preferably comprises a hole such as, for example, an aperture (27) and a slot (28). The aperture (27) is positioned in front of the fluid outlet (12) to allow for the removal or withdrawal of the ink. The slot (28) is positioned in front of the electrical contacts of the printed circuit board (15), thereby allowing for the printed circuit board (15) to be in electrical communication with the printing unit.

An alternative embodiment of the housing (20) comprises a configuration where the depth of the containment area (21) increases in the distal end (29) of the housing (20). Such an embodiment allows for the use of an ink bag assembly (10) containing a greater amount of ink than may be used with the typical housing. This embodiment allows the housing (20) to contain a large volume of ink, preferably accommodating an ink supply bag (16) containing approximately 2-liters or more of ink. Thus, this embodiment allows for longer operational time of a printing unit, thereby resulting in greater time efficiency.

A fitment-receiving mechanism (31) resides in the proximal end (25) of the housing (20), such that when the ink bag assembly (10) is properly loaded and positioned in the housing (20) and properly engaged with the printing unit, the appropriate electrical contacts and fluid communication are achieved. The fitment-receiving mechanism (31) is preferably formed to place and align the fitment (11) of the ink bag assembly (10) into position so that there is no substantial slippage or movement to result in a loss of electrical communication or fluid communication with the printing unit.

The housing (20) may further comprise a handle (32) such that it forms part of the body (33), where the body (33) and handle (32) are a substantially unitary structure. The handle (32) aids in the insertion of the ink cartridge (40) into the printing unit as well as its removal therefrom. The handle (32) is preferably comprised of the same type of materials used to construct the housing (20).

The embodiments of the present invention also contemplate an ink cartridge (40), which comprises the housing (20) having the ink bag assembly (10) inserted therein. The ink cartridge (40) may be easily inserted and removed from a printing unit.

The present invention also contemplates embodiments of a method of loading the embodiments of the housing (20) containing an ink bag assembly (10) into a printer comprising:

(i) inserting an embodiment of the ink bag assembly (10) of the present invention into a housing (20) (preferably re-useable), thereby forming an ink cartridge (40); and

(ii) inserting the ink cartridge (40) into a printer.

Typically, the ink bag assembly (10) may be placed into the housing (20) where the fitment (11) is positioned by the fitment receiving mechanism (31). Thus, the fluid outlet (12) and printed circuit board (15) are appropriately aligned with their respective holes in the proximal wall (26) of the housing (20) to allow for both fluid and electronic communication between the ink cartridge (40) and the printing unit. Subsequent to having loaded the ink bag assembly (10) into the housing to form an ink cartridge (40), the ink cartridge (40) may be inserted into the printing unit where upon its insertion; the ink may be withdrawn and utilized by the printing unit.

1. An ink bag assembly comprising:
(a) an ink supply bag; and
(b) a fitment fluidly connected to the ink supply bag via a means for fluid communication, wherein the fitment comprises an engageable member having a printed circuit board integrated therein or affixed thereto.

2. The ink bag assembly of claim 1, wherein the ink supply bag comprises a flexible multi-ply laminate having at least one plastic layer.

3. The ink bag assembly of claim 1, wherein the means for fluid communication is a fluid outlet comprising a fluid barrier.

4. The ink bag assembly of claim 1, wherein the printed circuit board is integrated with the fitment.

5. The ink bag assembly of claim 1, wherein the ink supply bag contains ink.
(a) an ink supply bag; and
(b) a fitment fluidly connected to the ink supply bag via a means for fluid communication, wherein the fitment comprises an engageable member having a printed circuit board integrated therein or affixed thereto.

6. The ink bag assembly of claim 1, wherein the ink supply bag comprises a flexible multi-ply laminate having at least one plastic layer, the means for fluid communication is a fluid outlet comprising a fluid barrier, the printed circuit board is integrated with the fitment, and the ink supply bag contains ink.

7. An ink cartridge comprising an ink bag assembly and a housing containing the ink bag assembly, wherein the ink bag assembly comprises:
(a) an ink supply bag; and
(b) a fitment fluidly connected to the ink supply bag via a means for fluid communication, wherein the fitment comprises an engageable member having a printed circuit board integrated therein or affixed thereto.

8. The ink cartridge of claim 7, wherein the ink supply bag comprises a flexible multi-ply laminate having at least one plastic layer.

9. The ink cartridge of claim 7, wherein the means for fluid communication is a fluid outlet comprising a fluid barrier.

10. The ink cartridge of claim 7, wherein the printed circuit board is integrated with the fitment.

11. The ink cartridge of claim 7, wherein the ink supply bag contains ink.

12. The ink cartridge of claim 7, wherein the ink supply bag comprises a flexible multi-ply laminate having at least one plastic layer, the means for fluid communication is a fluid outlet comprising a fluid barrier, the printed circuit board is integrated with the fitment, and the ink supply bag contains ink.

13. The ink cartridge of claim 7, wherein the housing comprises:
(1) a lid;
(2) a body comprising a floor, a plurality of sidewalls, a proximal end having a proximal wall, and a distal end optionally having a distal wall, wherein the lid and body are removeably connected and define a containment area; and
(3) a fitment-receiving mechanism in the proximal end of the containment area for receiving the fitment of the ink bag assembly.

14. The ink cartridge of claim 13, wherein the housing has a two-piece configuration.

15. The ink cartridge of claim 13, wherein the containment area has a depth that increases from the proximal end to the distal end.

16. The ink cartridge of claim 13, wherein the means for fluid communication of the fitment of the ink bag assembly is a fluid outlet, the proximal wall of the housing has an aperture positioned in front of the fluid outlet, the printed circuit board of the fitment of the ink bag assembly has electrical contacts, and the proximal wall of the housing has a slot therethrough positioned in front of the electrical contacts.

17. The ink cartridge of claim 13, wherein the ink supply bag comprises a flexible multi-ply laminate having at least one plastic layer, the means for fluid communication is a fluid outlet comprising a fluid barrier, the printed circuit board is integrated with the fitment, and the ink supply bag contains ink.
